(19) United States
(12) Patent Application Publication
(10) Pub. No.: US 2006/0114863 A1
(43) Pub. Date: Jun. 1, 2006

(54) Method to secure 802.11 traffic against MAC address spoofing

(75) Inventors: Ajit Sanzgiri, Los Gatos, CA (US); Robert C. Meier, Cuyahoga Falls, OH (US); Bhawani Sapkota, Fremont, CA (US); Nancy Cam Winget, Mountain View, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignee: Cisco Technology, Inc.

(21) Appl. No.: 11/000,629

(22) Filed: Dec. 1, 2004

(51) Int. Cl. H04Q 7/24

(52) U.S. Cl. 370/338; 726/3

(57) ABSTRACT

A method for protecting a wireless network against spoofed MAC address attacks. A database is used for storing MAC address and user identity bindings. When a new request to access the network is received, the MAC address and user identity of the request is compared to the stored MAC address and user identity bindings. If a new request has an existing MAC address, but not the corresponding user identity, then the request will be denied. The bindings database contains the MAC Address, User identity bindings for wireless nodes and/or, for wired nodes. The MAC address, User identity bindings contained in the bindings database may be automatically learned or statically configured.

### BACKGROUND OF THE INVENTION

The present invention relates generally to wireless communications and more specifically to techniques for protecting wireless networks.

The Institute of Electrical and Electronic Engineers (IEEE) 802.11 standard supplemented with the 802.11i extensions defines a way for authenticating users for admission into a wireless network and encrypting their traffic for confidentiality.

A weakness of the 802.11i standard is that it does not prevent a wireless “attacker” node from “spoofing” the Media Access Control (MAC) address, e.g., the Ethernet or 802.11 address of another node, because the 802.11i standard does not bind a user identity to a MAC address. When such an attacker spoofs the MAC address of another (second) node, then the network infrastructure may redirect frames intended for the second node to the attacker. The parent access point (AP) will transmit the redirected packets encrypted with the attacker's encryption key, preventing the node that should be receiving the packet from receiving them.

For example, consider the following scenario. An attacker node, A, snoops frames transmitted or received by another wireless client, e.g., B, and learns B's MAC address. This is easy to do as the MAC header of 802.11 frames are transmitted unencrypted over the air. Attacker node A can now associate with a wireless access point using B's MAC address. Once A associates with a wireless access point, traffic intended for B will now be directed to A, secured by a key allocated to A and decipherable by A. Other, more complex, attacks are also possible.

Generally, such attacks are limited to attackers that are on the same subnet. However, some wireless local area network (WLAN) solutions forward packets across subnet boundaries to provide seamless mobility to WLAN users. Unfortunately, such WLAN solutions are vulnerable to MAC address spoofing attacks where an attacker may spoof the address of a legitimate user on a different subnet, so that traffic intended for the legitimate user is redirected to the attacker across subnet boundaries.

### BRIEF SUMMARY OF THE INVENTION

In accordance with an aspect of the present invention, the present invention contemplates an authenticating entity that will verify the MAC address and user identity bindings of an incoming authentication request against existing MAC address and user identity bindings stored in a “bindings database.” If a new request has an existing MAC address, but not the corresponding user identity, then the request will be denied.

The bindings database contains the MAC Address, User identity bindings for wireless nodes and/or, for wired nodes. The MAC address, User identity bindings contained in the bindings database may be automatically learned or statically configured.

Still other objects of the present invention will become readily apparent to those skilled in this art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE SEVERAL VIEWS OF THE DRAWING

The accompanying drawings incorporated in and forming a part of the specification, illustrates several aspects of the present invention, and together with the description serve to explain the principles of the invention.

FIG. 1 is a flow diagram of a method in accordance with an aspect of the present invention.

FIG. 2 is a block diagram of a network configured in accordance with the present invention.

FIG. 3 is a block diagram of an authentication entity in accordance with an aspect of the present invention.

FIG. 4 is a flow diagram of an alternative method in accordance with an aspect of the present invention.

### DETAILED DESCRIPTION OF INVENTION

Throughout this description, the preferred embodiment and examples shown should be considered as exemplars, rather than limitations, of the present invention. The present invention resolves a security hole in the 802.11 wireless suites, where an attacker spoofs the MAC address of another wired or wireless user. The present invention compares new MAC address and User identity bindings against an existing database of bindings.

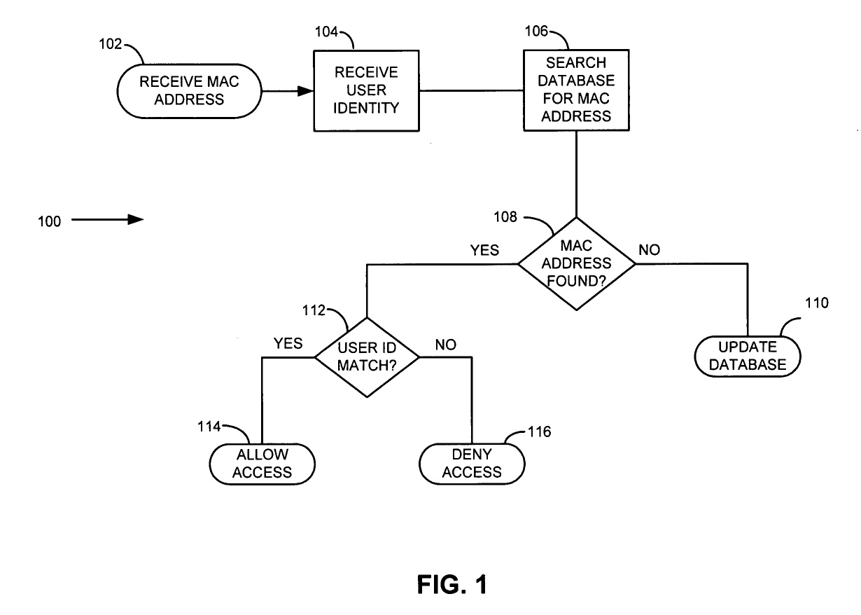

FIG. 1 is a flow diagram of a method 100 in accordance with an aspect of the present invention. While, for purposes of simplicity of explanation, the methodology 100 of FIG. 1 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

An authentication entity connected to the network being protected performs the methodology 100. The authentication entity can be any component on the network, e.g., a separate server, contained within an authentication server such as a RADIUS server, or contained within any access point or other network component can be configured to perform the functionality of the authentication entity as described herein.

At 102, a request for access to a network is received. The request is received from a wireless client. The request comprises a MAC address of the wireless client. However, in alternative embodiments of the present invention, wired components, such as new access points being connected to a network, attempting to access the network would also supply their MAC addresses.

At 104, a user identity corresponding to the MAC address received at 102 is received. In one embodiment, the user identity is received in the same message as the request with the MAC address. In an alternative embodiment, the user identity is sent in a separate message. For example, the current Institute of Electrical and Electronic Engineers (IEEE) 802.11i standard requires each authenticated user to send an Extensible Authentication Protocol (EAP) Identity message to an 802.1X authenticator within the network intrastructure. In one embodiment of the present invention, the user identity (UserID), which is bound to a MAC address is obtained from an EAP Identity message (e.g., the EAPID field) sent by the user.

An alternative method for obtaining the user ID is available for cases where a session key is used by the central authentication server (e.g., the AAA server) the first time the node authenticates. The authenticator (e.g., WDS) may cache this session key and establish a binding between the user ID (as learned from the EAP-ID) and this session key. When the node roams and reassociates with a new AP, it may not undergo the same sequence of authentication as before. In particular, the node may not furnish a user ID as an EAP-ID attribute. Instead, its reassociation message exchanged will furnish a checksum value (called MIC) that indirectly proves knowledge of the previously established session key without actually producing that session key (for privacy reasons). The authenticator (e.g., the WDS) will then use the indication of this knowledge of the session key by the wireless node and retrieve the user ID previously bound to this session key.

At 106, a database is searched for the MAC address. At 108, it is determined whether the MAC address was found in the database. If the MAC address does not already have an associated user identity (NO), then at 110 the database is updated. The database is updated by storing the association of the MAC address obtained at 102 with the user identity obtained at 104. Thus, subsequent requests for access to the network (such as an association request at another access point) will check that the user identity and MAC address match the user identity and MAC address stored at 110.

If, at 108, the MAC address is found in the database (YES), then at 112 the user identity received at 104 is compared with the user identity stored in the database. If at 112, the user identity received at 104 matches the user identity stored in the database for the MAC address received at 102, then at 114 the request is allowed. However, if at 112, it is determined that the user identity received at 104 does not match the user identity stored in the database for the MAC address received at 102 (NO), then at 116 access is denied, thus preventing a spoofed MAC address attack.

Alternative embodiments contemplate that in addition to or in lieu of denying access at 116 other actions may be taken in response to the detection of a spoofed MAC address attack. For example, instances of spoofed MAC address can be logged to as an exception at either a local and/or local server. Other alternative embodiments contemplate one or more generating SNMP traps, printing alert messages on a console (not shown), sending notifications, or other types of alarms can be generated.

Once a client (e.g. a wireless client or a wired component such as an access point) is stored in the database, when a subsequent request to access the network is received that has the client's MAC address, the MAC address for the requester can be verified. For example, at 102 the MAC address for the requestor for the subsequent request is obtained. At 104, the user identity for the requester of the subsequent request is obtained. At 106, the database is searched. Because the MAC address for the client is already stored, then at 108 the MAC address is found. At 112, the user identity for the subsequent request is compared to the user identity stored with the MAC address in the database. If at 112, the user identity for the subsequent request matches the user identity associated with the MAC address obtained at 102 (YES) then at 114 access is allowed, otherwise (NO) at 116, access is denied.

When a user logs out of the network, the database is updated and the user identity associated with the MAC address is either cleared, or the record is removed from the database. Thus, if another user begins to use the client, because the MAC address no long has an associated user name, the new user can log into the network. The authentication entity being responsive to a new user being associated with the MAC address, would update the database with the new user identity associated with the MAC address. Until the new user logs out, any attempt to access the network using the same MAC address without the correct user identity would be prevented by the authentication entity.

Alternatively, the authentication entity can remove the association of the MAC address with the user identity after a predetermined time occurs and no activity has been received by the user. This will allow the system to automatically log out a user identity when a device is powered off without logging out. Ordinarily, when no traffic has been received from a device for a few seconds (or as little as one) it is assumed that the device has been turned off.

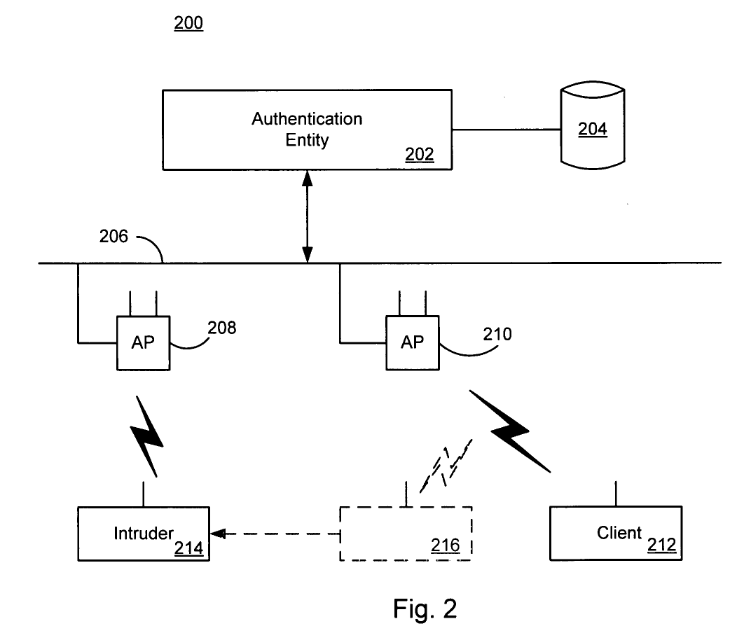

FIG. 2 is a block diagram of a network 200 configured in accordance with the present invention. The network comprises an authentication entity 202 coupled to a database 204. Access points 208 and 210 are coupled to authentication entity 202 via a network backbone 206. The network backbone 206 is used for secure communication between network components such as the access points 208, 210 and authentication entity 202, and comprises at least one of a wired and wireless segment. Access points 208 and 210 comprise wireless transceivers for communicating with a wireless client, such as wireless client 212.

When a client, such as client 212, wants to access network 200, it sends a wireless communication to at an access point (AP), such as access point 210 (as shown) or 208. The access point 210 is suitably adapted to determine the wireless client's 202 MAC address. Additionally, the access point 210 determines the wireless client's 202 user identity. AP 210 sends a message to the authentication entity 202 via network backbone 206 to ascertain whether the user identity matches the MAC address supplied by the client. The user identity can be obtained via an EAPID field of an EAP request. Alternatively, the user identity can be inferred from a MIC associated with the request.

Authentication entity 202 inquires database 204 for the MAC address. If the MAC address is not found, then a new entry is inserted into the database. Thus, when a subsequent request is received using the same MAC address, database 204 uses the entry to validate the request.

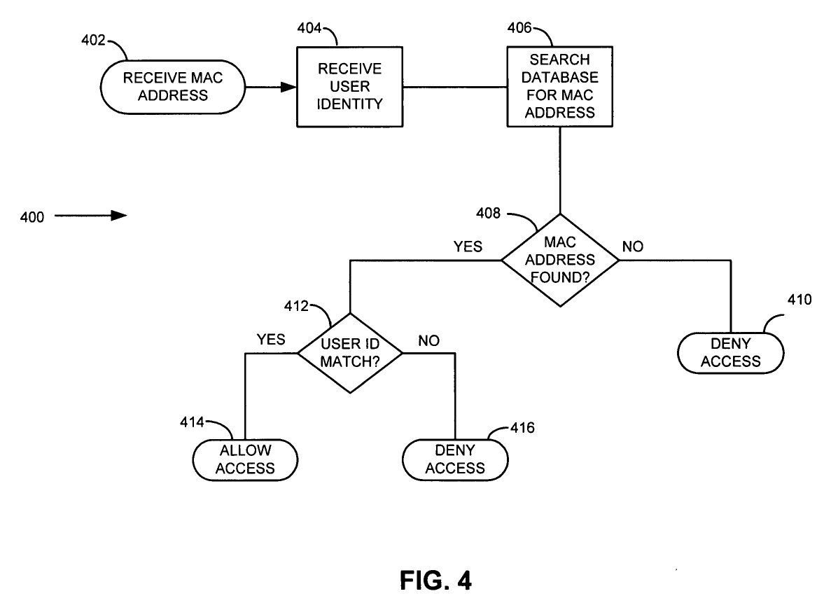

In an alternative embodiment, database 204 is configured to be static. When database 204 is configured to be static, then if the MAC address for client 212 is not found, it is denied access to the network. An example of this embodiment is illustrated in FIG. 4 and described hereinafter.

As shown, an intruder 214, while at position 216 overhears the client 212 communicating with AP 210. Because the MAC address for client 212 is sent unencrypted, intruder 214 is able to obtain the MAC address for client 212. Intruder 214 then communications with AP 208, requesting access to network 200 using the MAC address of client 212. AP 208 obtains a user identity for intruder 214. AP 208 then contacts authentication entity 202 via network backbone 206. When the authentication entity 202 compares the MAC address and user identity obtained sent by intruder 214 with the stored MAC address and user identity for client 212, authentication entity 202 determines that intruder 214 is using a spoofed MAC address. Authentication entity 202 then prevents intruder 214 from accessing the network by communicating to AP 208 that intruder 214 is not authorized to access the network.

In accordance with another aspect of the present invention, the present invention is useful to protect the network 100 infrastructure from rogue components accessing the network. For example, by configuring database 204 with a list of valid network components, for example access points, when a new access point 212 attempts to access the network 200 via network backbone 206, authentication entity ascertains the MAC address and if database 204 has been configured accordingly, the user identity for AP 212.

if AP 212 does not send the correct MAC address and/or user identity, then authentication entity prevents AP 212 from communicating with the rest of the network, for example by not distributing key pairs.

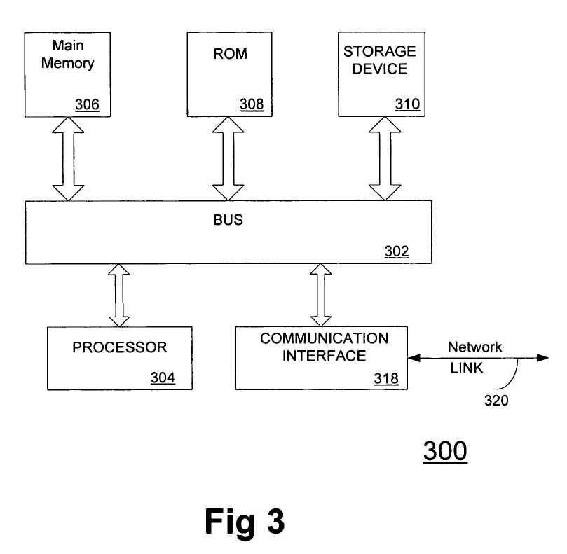

FIG. 3 is a block diagram of a computer system 300 configured to function as an authentication entity in accordance with an aspect of the present invention. Computer system 300 includes a bus 302 or other communication mechanism for communicating information and a processor 304 coupled with bus 302 for processing information. Computer system 300 also includes a main memory 306, such as random access memory (RAM) or other dynamic storage device coupled to bus 302 for storing information and instructions to be executed by processor 304. Main memory 306 also may be used for storing a temporary variable or other intermediate information during execution of instructions to be executed by processor 304. Computer system 300 further includes a ready only memory (ROM) 308 or other static storage device coupled to bus 302 for storing static information and instructions for processor 304. A storage device 310, such as a magnetic disk or optical disk, is provided and coupled to bus 302 for storing information and instructions. In accordance with an aspect of the present invention, storage device 310 includes a database. Processor 304 comprises instructions to search and update the database on storage device 310.

In accord with an aspect, the present invention is related to the use of computer system 300 for protecting a network against MAC address spoofing. According to one embodiment of the invention, protection against MAC address spoofing is provided by computer system 300 in response to processor 304 executing one or more sequences of one or more instructions contained in main memory 306. Such instructions may be read into main memory 306 from another computer-readable medium, such as storage device 310. Execution of the sequence of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to non-volatile media, volatile media, and transmission media. Non-volatile media include for example optical or magnetic disks, such as storage device 310. Volatile media include dynamic memory such as main memory 306. Transmission media include coaxial cables, copper wire and fiber optics, including the wires that comprise bus 302. Transmission media can also take the form of acoustic or light waves such as those generated during radio frequency (RF) and infrared (IR) data communications. Common forms of computer-readable media include for example floppy disk, a flexible disk, hard disk, magnetic cards, paper tape, any other physical medium with patterns of holes, a RAM, a PROM, an EPROM, a FLASHPROM, any other memory chip or cartridge, a carrier wave as described hereinafter, or any other medium from which a computer can read.

Various forms of computer-readable media may be involved in carrying one or more sequences of one or more instructions to processor 304 for execution. For example, the instructions may initially be borne on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector coupled to bus 302 can receive the data carried in the infrared signal and place the data on bus 302. Bus 302 carries the data to main memory 306 from which processor 304 retrieves and executes the instructions. The instructions received by main memory 306 may optionally be stored on storage device 310 either before or after execution by processor 104.

Computer system 300 also includes a communication interface 318 coupled to bus 302. Communication interface 318 provides a two-way data communication coupling to a network link 320 that is connected to a local network, such as for example network backbone 206 in FIG. 2. Communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic, or optical signals that carry digital data streams representing various types of information.

Network link 320 typically provides data communication through one or more networks to other devices on the network. For example, network link 320 may provide a connection to AP 208 and/or AP 210 (FIG. 2).

Furthermore, instruction code for processor 304 can be received from network link 320 using communication interface 318. The received code may be executed by processor 304 as it is received, and/or stored in storage device 310, or other non-volatile storage for later execution. In this manner, computer system 300 may obtain application code in the form of a carrier wave.

FIG. 4 is a flow diagram of a method 400 in accordance with an aspect of the present invention. This embodiment illustrates a method 400 wherein the database is statically configured, While, for purposes of simplicity of explanation, the methodology 400 of FIG. 4 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention. An authentication entity connected to the network being protected performs the methodology 400. The authentication entity can be any component on the network, e.g., an authentication server such as a RADIUS server, or any access point or other network component can be configured to perform the functionality of the authentication entity.

At 402, a request for access to a network is received. The request is received from a wireless client. The request comprises a MAC address of the wireless client. However, in alternative embodiments of the present invention, wired components, such as new access points being connected to a network, attempting to access the network would also supply their MAC addresses.

At 404, a user identity corresponding to the MAC address received at 402 is received. In one embodiment, the user identity is received in the same message as the request with the MAC address. In an alternative embodiment, the user identity is sent in a separate message, such as for example the EAPID field of an EAP message. Alternatively, for cases where a session key is used by the central authentication server (e.g., the AAA server) the first time the node authenticates the authenticator (e.g., WDS) may cache this session key and establish a binding between the user ID (as learned from the EAP-ID) and this session key. When the node roams and reassociates with a new AP, it may not undergo the same sequence of authentication as before. In particular, the node may not furnish a user ID as an EAP-ID attribute. Instead, its reassociation message exchanged will furnish a checksum value (called MIC) that indirectly proves knowledge of the previously established session key without actually producing that session key (for privacy reasons). The authenticator (e.g., the WDS) will then use the indication of this knowledge of the session key by the wireless node and retrieve the user ID previously bound to this session key.

At 406, a database is searched for the MAC address. At 408, it is determined whether the MAC address was found in the database. If the MAC address is not in the database (NO), then at 410 access to the network is denied. If, at 408, the MAC address is found in the database (YES), then at 412 the user identity received at 404 is compared with the user identity stored in the database. If at 412, the user identity received at 404 matches the user identity stored in the database for the MAC address received at 402, then at 414 the request is allowed. However, if at 412, it is determined that the user identity received at 404 does not match the user identity stored in the database for the MAC address received at 402 (NO), then at 416 access is denied, thus preventing a spoofed MAC address attack.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims interpreted in accordance with the breadth to which they are fairly, legally and equitably entitled.

1. A method to protect a network from MAC address spoofing, comprising:
receiving a request to associate with the network, the request having a MAC address;
receiving a user identity associated with the MAC address;
verifying the MAC address does not already have an associated user identity in a database; and
storing the association of the MAC address with the user identity in the database.

2. The method of claim 1, further comprising:
receiving a subsequent request to associate with the network with the MAC address;
receiving a user identity for the subsequent request to associate;
comparing the MAC address and the user identity received with the subsequent request to associate with the stored association of the MAC address with the user identity in the database; and
preventing access to the network responsive to the comparison of the MAC address and the user identity of the subsequent request not matching the stored association of the MAC address with the user identity.

3. The method of claim 1, further comprising:
receiving a subsequent request to associate, the subsequent request having the MAC address;
receiving the user identity with the subsequent request;
verifying the MAC address and user identity of the subsequent request match the stored association of the MAC address and user identity in the database; and
approving the request.

4. The method of claim 1, further comprising removing the association of the MAC address with the user identity after a user associated with the user identity logs out.

5. The method of claim 1, further comprising removing the association of the MAC address with the user identity after inactivity occurs for more than a predetermined time period

6. The method of claim 1, wherein the receiving a user identity further comprises obtaining the user identity from an EAPID field of an Extensible Authentication Protocol message.

7. The method of claim 1, further comprising:
receiving subsequent association requests from the same MAC;
obtaining the user identity obtained from a message integrity check;
comparing the user identity obtained from the message integrity check with the stored user identity associated with the MAC address.

8. A computer readable medium of instructions, comprising:
means for receiving a MAC address associated with a request for access;
means for receiving a user identity associated with request for access; and
means for accessing a database;
wherein the means for accessing a database responsive to the means for receiving a MAC address and means for receiving a user identity to verifying the MAC address does not already have an associated user identity in a database; and
wherein the means for accessing a database is responsive for storing the association of the MAC address with the user identity in the database.

9. The computer readable medium of instructions of claim 8, further comprising:
means for receiving a subsequent request to associate with the network with the MAC address;
means for receiving a user identity for the subsequent request to associate;
means for comparing the MAC address and the user identity received with the subsequent request to associate with the stored association of the MAC address with the user identity in the database; and
means for preventing access to the network responsive to the comparison of the MAC address and the user identity of the subsequent request not matching the stored association of the MAC address with the user identity.

10. The computer readable medium of instructions of claim 8, further comprising:
means for receiving a subsequent request to associate, the subsequent request having the MAC address;
means for receiving the user identity with the subsequent request;
verifying the MAC address and user identity of the subsequent request match the stored association of the MAC address and user identity in the database; and
approving the request.

11. The computer readable medium of instructions of claim 8, further comprising means for removing the association of the MAC address with the user identity after a user associated with the user identity logs out.

12. The computer readable medium of instructions of claim 8, further comprising means for removing the association of the MAC address with the user identity after inactivity occurs for more than a predetermined time period

13. The computer readable medium of instructions of claim 8, wherein the means for receiving a user identity further comprises means for obtaining the user identity from an EAPID field of an Extensible Authentication Protocol message.

14. The computer readable medium of instructions of claim 8, further comprising:
means for receiving subsequent association requests from the same MAC;
means for obtaining the user identity obtained from a message integrity check;
means for comparing the user identity obtained from the message integrity check with the stored user identity associated with the MAC address.

15. A network, comprising:
an authentication entity;
a database communicatively coupled to the authentication entity;
a first access point with a wireless transceiver for communicating with a wireless client;
a second access point with a wireless transceiver for communicating with the wireless client; and
a network backbone coupled to the first access point, the second and the authentication entity, enabling the first access point, second access point and authentication entity to communicate with each other;
wherein the first access point is configured to receive a message from the client via the wireless transceiver to access the network, the message having an associated MAC address and an associated user identity; and
wherein the authentication entity is configured to receive the request from the first access point, and upon verifying there is no entry for the MAC address in the database, updating the database by adding a new record into the database, the new record comprising the MAC address and the user identification.

16. The network of claim 15, further comprising:
the second access point suitably adapted to receiving a subsequent request to associate, the subsequent request having the same MAC address as the message;
the second access point suitably adapted to receiving a user identity for the subsequent request to associate;
the second access point responsive to forwarding the subsequent request, the MAC address and user identity for the subsequent request to the authentication entity;
the authentication entity configured to comparing the MAC address and the user identity received with the subsequent request to associate with the stored MAC address and user identity, and returning the results of the comparison to the second access point; and
the second access point responsive to preventing access to the network when the comparison of the MAC address and the user identity of the subsequent request do not matching the user identity stored with the MAC address.

17. The network of claim 15, further comprising the authentication entity configured to removing the new record from the database after a user associated with the user identity logs out.

18. The network of claim 15, further comprising the authentication entity configured to removing the new record the database after the client is inactive for more than a predetermined time period

19. The network of claim 15, wherein the first access point is configured to obtaining the user identity from an EAPID field of an Extensible Authentication Protocol message.
